(19) United States
(12) Patent Application Publication
(10) Pub. No.: US 2025/0122324 A1
(43) Pub. Date: Apr. 17, 2025

(54) REVERSIBLE POLYOL AND PRODUCTS CONTAINING THE SAME

(71) Applicants: CARGILL BIOINDUSTRIAL UK LIMITED, Weybridge, Surrey (GB); EQUUS UK TOPCO LIMITED, Weybrige Surrey (GB)

(72) Inventors: Wouter VOGEL, Zuid-Holland (NL); Angela Leonarda Maria SMITS, Zeist (NL)

(73) Assignee: CARGILL BIOINDUSTRIAL UK LIMITED, Weybridge, Surrey, EN (GB)

(21) Appl. No.: 18/291,312

(22) PCT Filed: Jul. 22, 2022
(86) PCT No.: PCT/IB2022/056797

§ 371 Date: Jan. 23, 2024

(30) Foreign Application Priority Data
Jul. 23, 2021 (GB) 2110601.8

(51) Int. Cl. C08G 18/36; C08G 18/28; C08G 18/44

(52) U.S. Cl. CPC C08G 18/36; C08G 18/283; C08G 18/44

(57) ABSTRACT

The present invention relates to a Diels Alder polyol (DA polyol), a polymer composition comprising the DA polyol, and use of the polymer composition comprising the DA polyol as a coating, adhesive, sealant, elastomer or composite. More specifically, Diels Alder polyol comprising: a) a Diels-Alder unit, wherein the Diels-Alder unit is capable of a DA/rDA reaction, and, b) a dimer fatty residue, wherein the DA polyol necessarily contains at least two functional groups selected from hydroxyl groups, amino groups and/or carboxyl groups.

### CROSS-REFERENCE TO RELATED APPLICATIONS

This application claims the benefit of United Kingdom Application No. 2110601.8, filed Jul. 23, 2021, which is incorporated by reference herein in its entirety.

### FIELD OF INVENTION

The present invention relates to a Diels Alder polyol (DA polyol), a polymer composition comprising the DA polyol, and use of the polymer composition comprising the DA polyol as a coating, adhesive, sealant, elastomer or composite.

### BACKGROUND

Polyurethanes are a broad and versatile class of polymers, formed from urethane bonds formed between an isocyanate and an alcohol (OH) reactant; usually both the isocyanate and alcohol reactants have a functionality of two or higher to ensure polymer formation. As such, the alcohol is often referred to as a polyol, and contains a hydroxyl function of at least two. The properties of polyurethanes may be “tuned” to a certain degree, according to the needs for the intended use of the polyurethane, for example by selecting different polyols and/or isocyanates. In addition, polyurethanes can include urea linkages which can increase stiffness and chemical resistance. Polyurethanes have been used in a wide variety of applications such as foam insulation, car seats, paint coatings, adhesives, sealants, elastomers, composites and abrasion resistant coatings. Polyols are also used in different polymer systems such as polyester, (co-)polyamides and polyacrylates for example.

Diels-Alder reaction (DA) chemistry is well-known, and an associated retro-Diels-Alder reaction (rDA) is also known to be possible, such that a Diels-Alder reaction can be reversible, or a DA/rDA sequence of reactions may be achieved. Some rDA reactions are known to happen spontaneously at room temperature, but others are known to require a thermal or chemical activation.

One of the most used pair of DA reactants, is the combination of furan and maleimide, which is shown below:

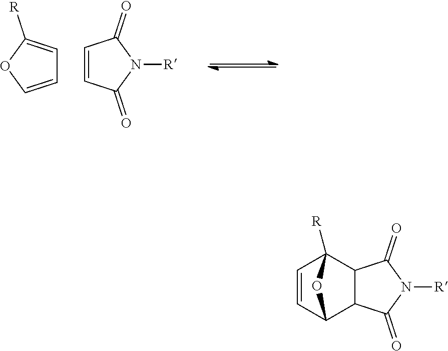

In “Thermal-Driven Self-Healing and Recyclable Waterborne Polyurethane Films Based on Reversible Covalent Interaction” (ACS Sustainable Chem. Eng. 2018, 6, 14490-14500) there is provided a DA diol suitable for incorporation into polymer chains, and in particular waterborne polyurethane polymers. The DA diol introduces a thermally reversible DA/rDA functionality (based on the furan and maleimide DA unit shown above) to the prepared polyurethane. The presence of the DA diol is taught as accomplishing a thermally triggered reversible dynamic covalent bond, which facilitates surface self-healing of the polymer.

As resources and raw materials around the globe become scarcer, and consumers are increasingly environmentally conscious, interest in product recycling, repair and circularity has increased.

When designing a circular product, one option is to make all the product components of the same type of material, such that all components may be jointly recycled. While for performance reasons dissimilar materials may still need to be used to provide different functions in a product. When several components in a product need to be joined, this is where adhesives may be utilised. As such, when the single type of material option is not feasible to achieve product circularity because of performance constraints or complexity of the final product (such as mobile phones, appliances, automotive parts), then debonding of adhesives within the product may offer a solution for decomposing of the final product into the different material types. One way, for example, is to design adhesives which can dissolve or debond and release in the recycling process, for example, using waterborne adhesives or hotmelts. An alternative way, for example, is to design adhesives to debond upon a trigger. Several technologies and triggers are possible, where the trigger may be part of the existing recycling process or additional external trigger. The present invention concerns providing adhesives (amongst other things) which debond when subject to a trigger.

Similarly, coatings may be released from the substrate to separate dissimilar materials for recycling of pure material streams. And composite resins may be released from the reinforcement fibre material to potentially re-use the fibres and recycle the resin.

Additionally, for repair of complex products, it can be advantageous to release a specific part of such product that requires repair or replacement. This prevents discarding of the entire product and reduces waste by extending the lifetime. The reversible technology of the current invention enables design for repairability.

Adhesives based on various polymer types are available. A good adhesive must have good mechanical properties and adhesion to a substrate. However, what properties are considered to be good might differ based on intended end-use and substrate materials. As such, a great many different adhesive polymer formulations are available. Polyurethane offers a versatile chemistry with the flexibility to design from soft to hard adhesives, with various polarities and adhesion strengths, various cross-link densities and crystallinity levels. Polyurethane adhesives can bind a wide variety of substrates, including wood, metals, and plastics. Therefore, polyurethane polymer adhesives can be found being used in a very broad range of applications. Yet, there are disadvantages to the current use of polyurethane polymer adhesives. Whereas two differing substrates held together with a bolt can be unscrewed and separated for reuse or recycling, adhesives usually cannot be readily detached form a substrate at the end of its useful life. As such, use of polymer adhesives highly limits the recyclability of the adhered substrates. Providing an adhesive that is both strong and yet debondable after use would be highly beneficial for the reuse and recycling rates of substrates, in particular those which are part of multi-layer materials and multi-material structures. Similar case of reuse and recycling benefits could be useful in relation to polyurethane coatings also, where the coating is applied to surfaces to which it adheres or bonds. Typically, polyurethane coating compositions may provide surface protective and/or decorative coating which may be applied to substrates and allowed to dry or cure to form a continuous protective and/or decorative layer. Such coatings may be applied to a wide variety of substrates including metals, wood, plastics, and plaster. Important properties of the formed film include hardness and resistance to water (i.e., hydrolysis resistance).

Similar recycling benefits and ease of reuse would be valuable for composites and composite structures also. In such composites typical fibres are glass, carbon and aramid or natural fibres like flax or bamboo that are used to reinforce a binder resin; binder resins are suitably polymers such as polyurethanes, epoxies and polyesters for example. Composites are often used in large structures with thermoset binder resins that cannot be melted for recycling (as they are not thermoplastic) and waste treatment is difficult. As such, provision of composites where the reinforcement fibres and the binder resin could readily become separable for reuse and/or recycling is desirable.

Polyurethane elastomers are often cast into a shape and especially the cross-linked structures cannot be reused or recycled. Furthermore, damage or ageing that causes cracks in the structures cause failure of the material. As such, there exists a need to provide elastomers which can more readily be reused, repaired and/or recycled.

Furthermore, substrates, which can be easily debonded from an applied coating, adhesive, sealant, elastomer or composite, without damaging the substrate, offer enhanced case of re-use and recycling of the substrate. As such, there exists a need to provide coatings, adhesives, sealants, elastomers and/or composites which may be easily debonded from the surface of a substrate. Additionally, such coatings, adhesives, sealants, elastomers and composites may aid in durability of the substrate by providing self-healing properties, or aid in circularity with debonding on demand and recyclability of composites/parts, in particular those which are part of multi-layer materials and multi-material structures.

Ideally, to make adhesives reversible, the polymer structure of the adhesive should be able to “fall apart” or debond when a certain stimulus is applied. As an adhesive may commonly be provided in between two substrates, it may be hard to reach by solvents or UV-light. Therefore, the most convenient stimulus to induce debonding may be thermal in nature. As such, a thermally triggered DA/rDA reaction present in an adhesive polymer may provide a suitable means of introducing a convenient bonding/debonding functionality to a polymer adhesive, particularly a polyurethane polymer adhesive, allowing for case of removal of the adhesive and reuse and recycling improvements. However, it has been found that the DA diol based on furan and maleimide described above, once incorporated into a polyurethane polymer, does not provide the polymer with physical and mechanical properties suitable for use as an adhesive.

The present invention provides a DA polyol comprising a dimer fatty residue. The presence of the fatty dimer residue in the DA polyol provides a polyurethane polymer prepared from the DA polyol with properties which allow for recycling benefits and ease of reuse as desirable for coatings, adhesives, sealants, elastomers and composites, and particularly where debonding of an adhered coating, adhesive, sealant, elastomer or composite from a substrate may aid recycling and reuse of the substrate and/or coating, adhesive, sealant, elastomer or composite. Additionally, the presence of the DA polyol comprising a dimer fatty residue in a polyurethane prepared from the DA polyol may also provide desirable intrinsic self-healing properties, which is desirable for achieving longevity of a product's useful life (particularly coatings, elastomers and composites) in advance of the product being recycled or reused.

### DETAILED DESCRIPTION OF THE INVENTION

In accordance with the present invention there is provided a Diels Alder polyol (DA olyol) comprising:
a) a Diels-Alder unit, wherein the Diels-Alder unit is capable of a DA/rDA reaction, and,
b) a dimer fatty residue.

Additionally, there is provided a polymer composition comprising the DA polyol of the present invention, and more especially a polyurethane polymer composition comprising said DA polyol.

Accordingly, the present invention also provides a method of making a polyurethane polymer comprising reacting a DA polyol of the first aspect with an isocyanate to form the polyurethane polymer.

Furthermore, there is provided a coating, adhesive, sealant, elastomer or

composite comprising a DA polyol, or a polyurethane polymer composition, in accordance with the alternative embodiments of the present invention.

It will be understood that any upper or lower quantity or range limit used herein may be independently combined.

It will be understood that, when describing the number of carbon atoms in a substituent group (e.g., ‘C1 to C6’), the number refers to the total number of carbon atoms present in the substituent group, including any present in any branched groups.

Many of the chemicals which may be used to produce the DA polyol or polyurethane of the present invention are obtained from natural sources. Such chemicals typically include a mixture of chemical species due to their natural origin. Due to the presence of such mixtures, various parameters defined herein can be an average value and may be non-integral.

The term ‘functionality’ as used herein with regard to a molecule or part of a molecule refers to the number of functional groups in that molecule or part of a molecule. A ‘functional group’ refers to a group in a molecule which may take part in a chemical reaction. For example, a carboxylic acid group, a hydroxyl group and an amine group are all examples of functional groups. For example, a diacid (with two carboxylic acid groups) and a diol (with two hydroxyl groups) both have a functionality of 2 and a triacid and triol both have a functionality of 3.

The term ‘dimer fatty residue’ as used herein, unless otherwise defined, refers to a residue of a dimer fatty acid (also referred to as a dimer fatty diacid) or a residue of a dimer fatty diacid derivative such as a dimer fatty diol or a dimer fatty diamine.

The term ‘polyol’ is well known in the art and refers to a molecule comprising more than one hydroxyl group. The term ‘active hydrogen’ refers to the hydrogen atoms present as part of the hydroxyl groups of the polyol.

### DA Polyol

Accordingly, the present invention provides a Diels Alder polyol (DA polyol) comprising:

A Diels Alder polyol (DA polyol) comprising:
a) a Diels-Alder unit, wherein the Diels-Alder unit is capable of a DA/rDA reaction, and,
b) a dimer fatty residue.

The DA polyol necessarily contains at least two functional groups, which allow it to react with an isocyanate to from a polyurethane. Preferably the at least two functional groups are selected from hydroxyl groups, amino groups and/or carboxyl groups. Preferably the at least two functional groups are hydroxyl groups.

Suitably, the DA polyol may be a diol, triol, tetrol, pentol or hexol. Preferably the DA polyol is a diol, triol or tetrol, more preferably a diol or triol. Most preferably, the DA polyol is a diol.

As will be understood by the skilled person, DA/rDA reactions involve the reversible reaction of a [4+2] cycloaddition of a diene and a dienophile, and accordingly the Diels-Alder unit (DA unit) of the present invention is provided by such a diene and dienophile.

Preferably, the Diels-Alder is capable of a thermally reversible DA/rDA reaction. Preferably the rDA reaction occurs at a temperature of between 40° and 125° C., more preferably 55° C. and 120° C. and most preferably between 75° C. and 110° C., as within this temperature range a polyurethane containing the DA unit may be caused to debond so that the polyurethane may be removed from a substrate onto which is has adhered, but the temperature will not be so high as to be degenerative for the rest of the polymer or any substrate to which the polymer may be applied to for its intended use. It should be understood that the DA reaction will take place at a temperature somewhat lower than the rDA reaction temperature, and for this invention preferably the DA reaction occurs at a temperature between 20° C. and 80° C., more preferably the DA reaction occurs at a temperature between 40° C. and 80° C., and most the DA reaction occurs at a temperature between 60° C. and 80° C.; ideally there will be a temperature difference of more than 5°, preferably more than 10° between the DA polyols respective DA and rDA reaction temperatures—this temperature difference ensures that the DA unit is stable, and the rDA reaction only occurs when intended.

Suitably, the DA unit may be provided by any diene and dienophile which is capable of a DA/rDA reaction. The diene may be either linear or cyclic, preferably the diene is cyclic, and most preferably the diene is a furan or a furan derivative. Preferably the diene comprises at least one functional groups are selected from hydroxyl groups, amino groups and/or carboxyl groups, and more preferably the diene is a furan, and the furan comprises a hydroxyl group, amino groups or carboxyl group, most preferably the diene is a furan and the furan comprises a hydroxyl group. The DA unit may preferably be provided by a furan and a maleimide or a furan and an acrylate. However, the DA unit could alternatively be provided by an Aza-DA unit provided by an imine and dienophile, or an Oxo-DA unit provided by a diene and an aldehyde. In the case the DA unit is provided by a furan and an acrylate, the acrylate is preferably a methacrylate, and most preferably a di(meth)acrylate. More preferably the DA unit is provided by a furan and a maleimide, most preferably a furan and a bismaleimide. A suitable furan may include a furan derivative such as, for example, a furfuryl alcohol or a polyol end capped with a furan (to provide a functional hydroxyl group) or furfuryl amine (to provide a functional amino group) and/or furoic acid (to provide a functional carboxyl group). Desirably, the furan component can be provided by a renewable, bio-based, compound derived from plant oils.

Suitably the DA polyol of the present invention comprises at least one DA unit and a dimer fatty residue. Within the DA unit one polyol may be present on the diene and one polyol present on the dienophile, such that the DA reaction occurs between these two different polyols. Alternatively, the DA polyol may comprise two DA units and a dimer fatty residue; in this embodiment, structurally, the dimer fatty residue is provided between the two DA units. Once incorporated into a polyurethane polymer, the presence of two covalent DA bonds within the DA polyol provides much more strength, which may be particularly favourable for application in adhesives.

The dimer fatty residue of the DA polyol may suitably be derived from a dimer diacid residue, a dimer diol residue, a dimer diamine residue and/or a dimer diisocyanate residue. More preferably the dimer fatty residue is derived from a dimer diacid residue, a dimer diol residue and/or a dimer diamine residue. Particularly preferably the dimer fatty residue is derived from a dimer diamine residue.

Preferably the dimer fatty residue of the DA polyol contains a total number of carbon atoms of between C20 to C60, more preferably C24 to C48, particularly C28 to C44, and especially C36. Suitable dimer fatty residues may be derived from the dimer fatty acids which include the dimerisation products of oleic acid, linoleic acid, linolenic acid, palmitoleic acid, and elaidic acid. The dimerisation products of the unsaturated fatty acid mixtures obtained in the hydrolysis of natural fats and oils, e.g., sunflower oil, soybean oil, olive oil, rapeseed oil, cottonseed oil and tall oil, may also be used. A dimer fatty acid may be converted to a dimer fatty diol, or alternatively to a dimer fatty diamine, as is known in the art. Dimer fatty diamines are particularly preferred in the present invention and are available ex Croda under the trade names “Priamine 1074” and “Priamine 1075”.

As described above, suitably in the present invention, the DA polyol is preferably provided by a DA unit provided by a furan and a maleimide, or alternatively the DA polyol is provided by a furan and an acrylate; in these cases the dimer fatty residue may be present in the furan or maleimide or acrylate part of the DA unit. For example, the dimer may be present as part of a dimer di(meth)acrylate, or a dimer based polyol end capped with a furan, or a dimer based maleimide; this allows for ease of use when manufacturing the DA polyol unit as the number of reaction steps required to initially form the DA polyol is reduced due to the dimer fatty residue being already present on one of the DA unit constituent parts. As such, the DA polyol may be obtainable by reacting a dimer based methacrylate (preferably a di(meth)acrylate) with a furan (or furan derivative such as furfuryl alcohol), or alternatively the DA polyol may be obtainable by reacting a dimer based polyol end capped with a furan derivative (to provide a furan group) with a methacrylate; suitable methacrylates include acrylic acid and 2-hydroxyethyl methacrylate. However, most preferably, the DA polyol is obtainable by reacting a furfuryl alcohol with a bismaleimide derived from a dimer fatty diamine (i.e., a dimer based bismaleimide), or alternatively, the DA polyol is preferably obtained by reacting a be obtainable by reacting a dimer based polyol end capped with a furan derivative (to provide a furan group) with a maleimide.

Alternatively, or additionally, a dimer based polyol may be end capped with a furan derivative (to provide a furan group) which is then reacted with a maleimide. Here the carbon chain provided by the fatty dimer residue as described above will be provided between two furan groups, where the furan group is attached to the nitrogen containing ring of the maleimide (to establish the DA unit); the maleimide may contain an aliphatic or aromatic carbon chain with a terminal OH group; the carbon chain length is not essential to the present invention. Suitably maleimide reactants may be, for example, N-(2-hydroxyethyl) maleimide or PEG-terminated maleimide which will provide the terminal OH groups.

As alluded to above, the fatty dimer residue may preferably be derived from a renewable and/or bio-based source. Preferably, both the fatty dimer residue and the DA unit are derived from renewable and/or bio-based sources. The level of bio-based content in the DA polyol may be determinable by ASTM D6866 as a standardised analytical method for determining the bio-based content or renewable carbon content of samples using ¹⁴C radiocarbon dating. ASTM D6866 distinguishes carbon resulting from bio-based inputs from those derived from fossil-based inputs. Using this standard, a percentage of carbon from renewable sources can be calculated from the total carbon in the sample; preferably the DA polyol comprises at least 25% biobased content, and more preferably at least 40% biobased content, and most preferably at least 60% biobased content. As more biobased chemical feedstocks become available it is conceivable that higher levels of biobased content could be achieved.

Preferably the DA polyol comprises from 10 to 80 wt % dimer fatty residue, more preferably the DA polyol comprises from 15 wt % to 70 wt % dimer fatty residue, and most preferably the DA polyol comprises from 20 wt % to 60 wt % dimer fatty residue based on the total weight of the DA polyol.

Additionally, there is provided a polymer composition comprising the DA polyol as described above. Suitable polymer compositions may include polyurethanes, polyesters, (co-)polyamides, epoxies, polycarbonates, polyacrylates, and combinations of different polymer types. Mixed polymer compositions can be made, containing differing types of polymers, whilst still providing a reversible material due to the presence of at least some DA polyol as described above. Such mixed polymer compositions will consist of a combination of reversible bonds and covalent bonds, which can consist of combinations or mixtures of two of more polymers (i.e., an interpenetrating polymer network) or by having both bond-types built into one polymer.

Preferably, the polymer composition comprises the DA polyol as described above and an isocyanate. The polymer composition may be a mixture of the isocyanate and DA polyol. Preferably the polymer composition comprises a polyurethane formed from the reaction of the DA polyol and an isocyanate.

The polymer composition comprising a mixture of the isocyanate and DA polyol may be considered to be a “pre-polymer”, when isocyanate is used in excess over polyol and is conveniently referred to as such in this description.

The isocyanate and DA polyol may be reacted to form a polyurethane, the reaction may be instigated via any suitable means, for example, by curing via elevated temperature, or by introduction of an initiator catalyst, or by moisture curing. More especially, the DA polyol and isocyanate may be reacted (cured) at an elevated temperature, and said elevated temperature may preferably be in the range from 50° C. to 80° C., and more preferably, in the range from 60° C. to 75° C.; such curing temperature should preferably be below the relevant DA polyol rDA reaction temperature. Suitably, the isocyanate and DA polyol may be directly reacted, or alternatively they may be pre-mixed to form a homogenous mixture and then subsequently reacted. Alternatively, moisture curing to form the polyurethane may be preferred, as this method of curing will avoid any problems with selection of a thermal curing temperature sufficiently lower than the rDA temperature of the DA polyol. As such, the present invention may advantageously provide an ambient cure system.

In the reacted polyurethane polymer, the NCO:OH ratio employed is preferably in the range from 0.8 to 3:1, however, the ratio employed depends largely upon whether the polymer is to be formed in a one component system (1K) or a 2 component system (2K). As such, for a 1K system the NCO:OH ratio employed is preferably in the range from 1 to 3:1, more preferably 1.2 to 2.5:1, and particularly 1.5 to 2:1, but for a 2K system the NCO:OH ratio employed is preferably in the range from 0.8 to 1.2:1, more preferably 0.9 to 1.1:1, and most preferably 1 to 1.03:1.

The polymer composition may preferably have an isocyanate content (measured in accordance with ASTM 2572) in the range from 5 wt % to 30 wt %, more preferably 10 wt % to 23 wt %, particularly 15 wt % to 20 wt %, and especially 18 wt % to 19 wt % NCO.

The isocyanate preferably comprises at least one isocyanate which has a functionality of at least 2.

The isocyanate may be an aliphatic isocyanate, cycloaliphatic or an aromatic isocyanate. In some embodiments the isocyanate is preferably an aliphatic isocyanate. However, in some alternative embodiments preferably, the isocyanate may be an aromatic isocyanate. More especially, an aliphatic isocyanate is preferred when the polymer composition is utilised in coatings, and an aromatic isocyanate is preferred when the polymer composition is utilised in a adhesives, elastomers and/or composites; this is because aliphatic isocyanates have an increased thermal and light stability compared to aromatic isocyanates, but aromatic isocyanates have increased reactivity and strength compared to aliphatic isocyanates.

Suitably, the polymer composition may comprise an isocyanate selected from one or more of an isocyanate, a polyisocyanate, a diisocyanate, or a triisocyante; such isocyanate monomers may be used alone or as mixtures thereof. Preferably the one or more isocyanate of the polymer composition is a diisocyanate.

A suitable isocyanate may be selected from one or more of the following; hexamethylene 1,6-diisocyanate, isophorone diisocyanate (IPDI) ethylene diisocyanate, 1,2-diisocyanatopropane, 1,3-diisocyanatopropane, 1,6-diisocyanatohexane, 1,4-butylene diisocyanate, lysine diisocyanate, hexamethylene diisocyanate (HDI), 1,4-methylene bis-(cyclohexyl isocyanate) and isophorone diisocyanate, from toluene diisocyanate, m-phenylene diisocyanate, p-phenylene diisocyanate, xylylene diisocyanate, 4,4′-diphenylmethane diisocyanate, polymethylenepolyphenyl diisocyanate, 3,3′-dimethyl-4,4′-biphenylene diisocyanate, 3,3′-dimethyl-4,4′-diphenylmethane diisocyanate, 3,3-dichloro-4,4′-biphenylene diisocyanate, 1,5-naphthalene diisocyanate, or modified compounds thereof. As such, suitable aromatic isocyanates may be selected from one or more of the following: toluene diisocyanate, m-phenylene diisocyanate, p-phenylene diisocyanate, xylylene diisocyanate, 4,4′-diphenylmethane diisocyanate, polymethylenepolyphenyl diisocyanate, 3,3′-dimethyl-4,4′-biphenylene diisocyanate, 3,3′-dimethyl-4,4′-diphenylmethane diisocyanate, 3,3-dichloro-4,4′-biphenylene diisocyanate, 1,5-naphthalene diisocyanate, or modified compounds thereof, and uretonimine-modified compounds thereof may be particularly preferred.

Aliphatic polyisocyanates may be preferred, particularly hexamethylene diisocyanate and/or isophorone diisocyanate, and this embodiment is especially preferred when the polymer composition is to be used to provide a coating composition.

Additionally, or alternatively, 4,4′-diphenylmethane diisocyanate (MDI) is a particular preferred example. In one preferred embodiment, (MDI) is used alone, and in an alternative embodiment a mixture of MDI and a uretonimine-modified 4,4′-diphenylmethane diisocyanate (modified MDI) is preferably employed. such as uretonimine-modified compounds thereof. This embodiment is especially preferred when the polymer composition is to be used to provide an adhesive.

Also suitable for use are the biurets, allophanates and/or isocyanurates of such aliphatic or aromatic polyisocyanates. Preferred for use in the invention are the biurets and isocyanurate of polyisocyanates, especially of the aliphatic polyisocyanates such as hexamethylene diisocyanate and isophorone diisocyanate. Most preferred are the biurets and isocyanurates of hexamethylene diisocyanate. This embodiment is especially preferred when the polymer composition is to be used to provide a coating, and more especially specialty coatings may utilise biurets and isocyanurates.

The polymer composition comprising the DA polyol may preferably be incorporated into a more complex polymer resin or binder system. In this case the polymer composition of the present invention is further mixed and/or reacted with one or more additional polymer. In this embodiment of the present invention, it is convenient to refer to the additional polymer as a binder polymer. As such the polymer composition may comprise a binder polymer.

Preferably the binder polymer is selected from poly(meth)acrylates, polyurethanes, polyesters, polyamide and co-polymers thereof. The binder polyurethane polymer may comprise a (meth)acrylic polymer polyol, an acrylic urethane polymer polyol, polycarbonate polyol or a polyester polyol.

More preferably the binder polymer is a polyurethane binder made from hydroxyl functional polyol, and most preferably the binder polymer polyol has a hydroxyl function of at least two. The hydroxyl-functional binder should typically have a number average molecular weight (Mn), as determined by gel permeation chromatography, of from about 500 to 50,000, preferably about 1,000 to 10,000; a hydroxyl value of from about 20 to 300, preferably from 30 to 250 mg KOH/g of polymer; an acid value (based on solids) of from 0 to 150, preferably from 0 to 100 mg KOH/g of polymer; and, a content of sulfonic acid and/or carboxyl groups of from 5 to 450, preferably 20 to 300 milliequivalents per 100 g of polymer (solids). Such hydroxyl-functional binder polyols can of course be obtained from known commercial sources; in which case it is preferred to use solvent-borne commercial products because these require little pre-processing before employment in the present invention. Examples of such commercial resins which may be mentioned are: Desmophen™ A 450 BA, Desmophen A 450 BA/X, Desmophen 800, Desmophen 1200 and Desmophen 670 (all available from Covestro); Albodur™ 912, Albodur 903, Albodur 941 (all available from Alberdingk-Boley) and Synthalat 1633, Synthalat 1653 and Synthalat A 333 (all available Synthopol).

Optionally, the binder polymer of the polymer composition may contain one or more further polymeric polyols having 2 or more hydroxyl groups which are capable of reacting with an isocyanate group. These optional, further polymeric polyols are preferably substantially linear and have a molecular weight in the range from 300 to 20,000, preferably in the range from 500 to 2,500. Preferred polymeric polyols are polyesters, polyacetals, polycarbonates, polyethers, polythioethers, polyamides and/or polyester amides containing on average 2 to at most 4 hydroxyl groups. The presence of such polymer polyols modifies the properties of the end product prepared or formed from the polymer composition.

In one particularly preferred embodiment of the invention, at least one of the aforementioned isocyanates is reacted with at least one of the aforementioned polyesters, to form said pre-polymer; the pre-polymer will be subsequently reacted with the DA polyol of the present invention to form a polymer composition of interest.

The ratio of isocyanate to polyester starting materials which are mixed together to react to form the pre-polymer is preferably in the range from 20 to 80:20 to 80, more preferably 35 to 75:25 to 65, particularly 45 to 70:30 to 55, and especially 55 to 65:35 to 45 by weight.

The isocyanate is preferably used in molar excess relative to hydroxyl group content of the polyester, so as to obtain a reaction mixture containing isocyanate-terminated pre-polymer and sufficient unreacted isocyanate, such that later addition of the chain extender (as further described below) can result in reaction to form the polyurethane polymer of the present invention, without the requirement for adding further isocyanate.

Optionally, the polymer composition may further comprise at least one polyol. This polyol is distinct to the DA polyol described above, although said polyol may also be considered to be a diol if only two hydroxyl groups are present. The at least one polyol may be selected from any polyol known to the skilled person to be useful in polyurethane polymers. Suitably, the at least one polyol may be selected from polyether, polyester, polycarbonate and polycaprolactone polyols. Polyether polyols are particularly suitable for low temperature applications of the final polymer, they have a low viscosity (40-15,000 mPa s) and are relatively low in cost, however they are sensitive for degradation when exposed to heat in presence of oxygen. Polyester polyols, relative to polyether polyols, provide a better resistance to light and thermal degradation, however their hydrolytic stability is less. For polyurethane polymer adhesives the inclusion of polyester polyols may enhance the wetting and adhesion of the adhesive to some substrates and they also show good mechanical properties in terms of modulus, strength and stiffness as such the inclusion of a polyester polyol in a polymer composition of the present invention may be particularly preferred. Polycarbonate polyols are highly stable against hydrolysis and oxidation and can provide advantageous modulus and both tensile and shear strength. Polycaprolactone polyols are generally considered as a special high-performance class of polyester polyols, they also generally considered to provide very good tear and cut strength properties, but unfavourable elongation properties for some applications.

Additionally, or alternatively, the polymer composition may further comprise at least one dimer-based polyester polyol. The inclusion of at least one dimer-based polyester polyol may provide for improved hydrolytic stability and higher flexibility versus conventional polyester polyol as described above. Examples of such commercial resins which may be utilised are: Priplast 1838 and Priplast 3192 (available from Croda).

Optionally, the polymer composition may further comprise a chain extender. The chain extender may be in the form of a chain extender composition. Suitable chain extenders are known in the art. The chain extender composition is preferably prepared by simple pre-mixing of, for example, the chain extender and other additives (such as blowing agent, and/or urethane catalyst, and/or pigment and/or filler and/or blowing agent) which it may be desirable to introduce to the polymer composition. The at least one polyol (described above) may be added together with the chain extender to react with the other polymer composition components in order to form the polyurethane.

The chain extender, or chain extender composition, used to form the polymer suitably comprises two or more active hydrogen groups, for example the chain extender, or chain extender composition, comprises a polyol. Preferably, the chain extender, or chain extender composition comprises a low molecular compound having two or more active hydrogen groups, for example polyols such as ethylene glycol, diethylene glycol, propylene glycol, 1,4-butylene glycol, 1,5-pentylene glycol, methylpentanediol, isosorbide (and other iso-hexides), 1,6-hexylene glycol, neopentyl glycol, trimethylolpropane, hydroquinone ether alkoxylate, resorcinol ether alkoxylate, glycerol, pentaerythritol, digylcerol, and dextrose; dimer fatty diol; aliphatic polyhydric amines such as ethylenediamine, hexamethylenediamine, and isophorone diamine; aromatic polyhydric amines such as methylene-bis(2-chloroaniline), methylenebis(dipropylaniline), diethyl-toluenediamine, trimethylene glycol di-p-aminobenzoate; alkanolamines such as diethanolamine, triethanolamine and diisopropanolamine.

In a preferred embodiment of the invention, the chain extender is a polyol, more preferably a diol, particularly having an aliphatic linear carbon chain comprising in the range from 1 to 10, and especially 3 to 5 carbon atoms. Preferred diols include ethylene glycol, propylene glycol, 1,4-butylene glycol, and 1,5-pentylene glycol. 1,4-butylene glycol is particularly preferred.

The presence of additional hydroxyl functionality will modify the properties of the DA polyol containing polymer and may better “tune” the polymers physical properties for its intended use, for example, the presence of both the DA polyol and the chain extender polyol or at least one further polyol may provide improved adhesive properties to the polymer rendering it particularly suited to its intended use. As will be appreciated by the skilled person, polyols suitable for use as chain extenders will be short chain polyols able to form short linkages between two isocyanate monomers providing harder, less elastic polymer segments, whereas polyols suitable for use as said at least one polyol will be longer in chain length and will increase the mobility of the polymer adding more soft segments and more elastic properties to the polymer.

Desirably, the polymer composition may comprise one or more optional additives. These additives may be selected from pigments, dyes, rheology modifiers, fillers, catalysts, stabilisers, emulsifiers, dispersants, and other surfactants. The optional additives may preferably be present in addition to the binder polymer described above and may be selected by the skilled person dependent upon the intended final use or product to be produced by the polymer composition.

A pigment additive may be organic or inorganic. Examples of organic pigments are azo pigments, phthalocyanine, quinacridone. Examples of inorganic pigments are iron oxide pigments, titanium dioxide and carbon black.

Examples of dyes are azo, azine, anthraquinone, acridine, cyanine, oxazine, polymethine, thiazine and triarylmethane dyes. These dyes may be employed as basic or cationic dyes, metal complex, reactive, acid, sulphur, coupling or substantive dyes.

Suitable catalysts include known polyurethane catalysts, which will facilitate reaction of an isocyanate and a polyol to form a polyurethane; examples include compounds of divalent and tetravalent tin, more particularly the dicarboxylates of divalent tin and the dialkyl tin dicarboxylates and dialkoxylates. Specific examples include dibutyl tin dilaurate, dibutyl tin diacetate, dioctyl tin diacetate, dibutyl tin maleate, tin (II) octoate, tin (II) phenolate, and the acetyl acetonates of divalent and tetravalent tin. In addition, tertiary amines or amidines may also be employed, either alone or in combination with the aforementioned tin compounds. Examples of suitable amines include tetramethyl butane diamine, bis-(dimethylaminoethyl)-ether, 1,4-diazabicyclooctane (DABCO), 1,8-diazabicyclo-(5.4.0)-undecane, 2,2′-dimorpholinodiethyl ether, dimethyl piperazine, and mixtures thereof.

Suitable stabilizers include materials which stabilize the viscosity of the polyurethane during its production, storage and application, and include monofunctional carboxylic acid chlorides, monofunctional highly reactive isocyanates, and non-corrosive inorganic acids. Examples of such stabilizers are benzoyl chloride, toluene sulfonyl isocyanate, phosphoric acid or phosphorous acid. In addition, suitable hydrolysis stabilizers include for example the carbodiimide type. Stabilizers which are antioxidants or UV absorbers may also be used. Examples of such stabilizers are HALS hindered amine light stabilisers, hydrogen-donating antioxidants such as hindered phenols and secondary aromatic amines, benzofuranone, oxanilides, benzophenones, benzotriazoles and UV absorbing pigments.

Suitable surfactants include silicone surfactants such as dimethylpolysiloxane, polyoxyalkylene polyol-modified dimethylpolysiloxane and alkylene glycol-modified dimethylpolysiloxane; and anionic surfactants such as fatty acid salts, sulphuric acid ester salts, phosphoric acid ester salts and sulphonates.

Preferably, for some applications or end uses, the polymer composition is provided as a two component (2K) polyurethane resin system. This is particularly preferred where the polymer composition is to be utilised to produce a coating composition. In said 2K polyurethane system, the DA polyol of the present invention and a binder polymer may provide the first component of the resin system and a polyisocyanate may provide the second component of the resin system. In this embodiment one or more optional additives may be provided in either the first or second component. Such a 2K system is particularly preferred for the preparation of coatings and cast elastomers or composites comprising or consisting of the polymer composition. As such, the present invention may preferably provide a coating or cast elastomer or composite composition comprising a polymer composition as described herein, and hence preferably comprising the DA polyol, binder polymer and polyisocyanate, as described above.

Accordingly, the present invention also provides a method of making a polyurethane polymer comprising reacting a DA polyol of the first aspect with an isocyanate to form the polyurethane polymer. The DA polyol of the present invention is suitable for use in conventional methods of making polyurethane polymers.

A polymer composition according to the present invention may find utility in a wide range of applications, where the presence of the DA polyol in the polymer will provide advantages in terms of case of repair, recycling, reuse and product circularity, as alluded to above. In addition, the polymer compositions of the present invention may find particular utility in additive manufacturing (AM) processes, such as Fused Deposition Modeling (FDM) of filament, Selective Laser Sintering (SLS) of powder or Stereolithography (SLA) of liquid. The presence of the DA polyol material in the polymer composition will allow the polymer composition to soften and flow at a lower temperature than would be achieved for the polymer composition without the DA polyol material. This will allow for lower operating temperatures to be employed giving rise to cost and energy savings. Furthermore, use of lower operating temperatures in additive layer manufacturing process can overcome problems associated with final product thermal warping or detachment from the print bed. Additionally, or alternatively, the presence of the DA polyol may allow for additive layer manufacturing processes to employ polymers which would ordinarily be degraded at the temperature required to ensure flowability (in the absence of the DA polyol) allowing for a wider range of polymers to be utilised in, for example, 3-D printing techniques.

Additionally, or alternatively, there is provided a coating, adhesive, sealant, elastomer or composite comprising a DA polyol, or a polymer composition (comprising the DA polyol), as described above. In accordance with a particular preferred embodiment of the present invention there is provided an adhesive comprising a DA polyol as described above, or comprising a polymer composition (comprising the DA polyol) as described above. Preferred features in relation to the adhesive are provided above in relation to the description of the preferred features of the polymer composition.

An adhesive according to the present invention may be applied to a substrate, to which it will adhere, more especially the adhesive of the present invention may be applied in between two or more layers of substrate; in this case the substrate layers may be the similar or dissimilar in nature. Application of the adhesive to a substrate may be provided by any number of techniques including spray, brush, roller, paint mitt, and others as known in the art. Numerous substrates are suitable for application of the adhesive, and suitably the substrate may be selected from metal, particularly steel and aluminium, wood, and/or plastic. In a similar manner, a composite comprising a binding resin comprising the DA polyol of the present invention may be applied and adhered to fibre reinforcements, and this may also be a particularly preferred embodiment of the present invention.

An advantage of utilising the DA polyol having thermally reversible rDA bonds in an adhesive polymer is that the DA polyol will enable debonding of the adhesive or composite from an adhered substrate, re-bonding of separated substrates (for reuse) and/or recycling of the adhesive or composite itself by re-crosslinking the adhesive or composite after separation from a previously adhered substrate and/or recycling of the composite fibres by debonding and separation of the polymer.

In accordance with a particular preferred alternative embodiment of the present invention there is provided a coating comprising a DA polyol as described above, or a polymer composition (comprising said DA polyol) as described above. Preferred features in relation to the coating are provided above in relation to the description of the preferred features of the polymer composition.

The coating may comprise at least 1 wt % polyisocyanate, preferably at least 2 wt %, particularly at least 5 wt %, desirably at least 10 wt %, all based on the total weight of the coating composition. The coating may comprise at most 50 wt % polyisocyanate, preferably at most 40 wt %, particularly at most 30 wt %, all based on the total weight of the coating.

The molar ratio of free isocyanate groups to free hydroxyl groups in the solids part of the coating composition prior to curing (NCO/OH ratio) may be at least 0.7, preferably at least 0.8, more preferably at least 0.9, particularly at least 1. The NCO/OH ratio may be at most 3, preferably at most 2.5, more preferably at most 2, particularly at most 1.8. A higher NCO/OH ratio may provide improved hardness and/or chemical resistance to a cured coating.

The coating may have a total solids content, according to DIN EN ISO 3251 of at least 25 wt %, preferably at least 30 wt %, more preferably at least 35 wt %, particularly at least 40 wt %, based on the total weight of the coating composition. The coating may have a total solids content of at most 80 wt %, preferably at most 70 wt %, more preferably at most 65 wt %, particularly at most 60 wt %, based on the total weight of the coating. Alternatively, the coating may be considered to be low solvent to solvent-free and have a total solids content of at least 90%, preferably at least 95%, most preferably 99 to 100%.

The coating may comprise at least 10 wt % water, preferably at least 20 wt % water, particularly at least 30 wt % water, all based on the total weight of the coating. The coating may comprise at most 90 wt % water, preferably at most 80 wt % water, particularly at most 70 wt % water, all based on the total weight of the coating composition.

The coating may preferably comprise one or more additive, especially a colorant additive for example a pigment and/or dye.

The coating may be a clearcoat. The coating may be transparent or substantially transparent, preferably the coating composition is transparent. The coating may not comprise a colorant additive for example it may not comprise a pigment and/or dye.

A coating according to the present invention may be applied to a substrate. Application of the coating to a substrate may be provided by any number of techniques including spray, brush, roller, paint mitt, dip and others as known in the art. Numerous substrates are suitable for application of the coating. The substrate to be coated may be selected from metal, particularly steel and aluminium, wood, brick, concrete, and plastic. The substrate may be an exterior wall, interior wall or floor. An advantage of utilising the DA polyol having thermally reversible rDA bonds in a coating polymer is that the DA polyol will enable debonding of the coating from a substrate which the coating has adhered to, re-bonding of separated substrates (for reuse) and/or recycling of the coating polymer itself by re-crosslinking the coating polymer after separation from the surface of a substrate to which the coating had been previously adhered.

Suitably, the coating may be applied as a primer coating on to the substrate. A further coating layer such as an overcoat or topcoat may be applied on top of the primer coating. Additionally, or alternatively, the present coating composition may be applied as a topcoat. The coating may be provided as a paint or lacquer, preferably a paint.

In accordance with a particular preferred alternative embodiment of the present invention there is provided an elastomer comprising a DA polyol as described above, or a polymer composition (comprising said DA polyol) as described above. Preferred features in relation to the elastomer are provided above in relation to the description of the preferred features of the polymer composition. Preferably, the elastomer is a cast elastomer formed from a cast polymer made from a 2K system. However, 1K methods of forming the elastomer polymer may be utilised as an alternative, and this is particularly suitable for providing elastomers formed from thermoplastic polyurethane (TPU) comprising the DA polyol of the present invention.

In accordance with a particular preferred alternative embodiment of the present invention there is provided a composite comprising a DA polyol as described above, or a polymer composition (comprising said DA polyol) as described above. Preferred features in relation to the composite are provided above in relation to the description of the preferred features of the polymer composition. Preferably the composite is a fibre reinforced composite.

All of the features described herein may be combined with any of the above aspects, in any combination.

### EXAMPLES

The invention is illustrated by the following non-limiting examples.

It will be understood that all test procedures and physical parameters described herein have been determined at atmospheric pressure, room temperature (i.e., about 20° C.) and a relative humidity of 50% unless otherwise stated herein, or unless otherwise stated in the referenced test methods and procedures. All parts and percentages are given by weight unless otherwise stated.

Materials used in the examples are identified as follows:
BMI—Bismaleimide resin 689—a liquid bismaleimide containing a non-hydrogenated dimer diamine backbone (ex. Designer Molecules Inc.),
FA—furfuryl alcohol (ex. Sigma Aldrich),
PC—polycarbonate polyol (diol) (ex. Asahi Kasei chemicals),
(polymeric) 4,4-MDI mixture Desmodur™ VK10L—a mixture of diphenylmethane-4,4′-diisocynate with isomers of higher functional homologues (PMDI) (ex. Covestro AG),
PP—Pripol™ 2043—a 100% bio-based dimer diol (ex. Croda),
SH—CroHeal™ 1000—a polyol suitable for facilitating intrinsic self-healing in polyurethane polymers (ex. Croda).

### Example 1—DA Polyol Preparation

A DA polyol containing a dimer fatty residue in accordance with the present invention was prepared as follows: BMI was weighed in a 500 mL, 4-neck round bottom flask and heated to 50° C. under a nitrogen atmosphere. FA was added gradually to the BMI to form the DA polyol (DA reaction occurs). The C—C bond formation of the DA reaction was exothermic reaction and caused an increase in temperature to 80° C. Once this 80° C. temperature was reached, to avoid further temperature increase, the heat was removed, and the flask was placed in a cold-water bath. After complete addition of FA, the temperature was kept at 70° C. for 7 hours. The reactants and the resulting DA polyol was analysed via ¹H NMR to characterise the synthesised DA polyol utilising a Magritek Spinsolve 60 carbon Spectrometer, in chloroform at 60 MHz Samples were taken and analysed ever two hours to ensure that the reaction was complete. The ¹H NMR spectra obtained clearly showed the presence of the dimer material retained in the final DA polyol example material. 1H NMR spectra obtained on a sample 8 weeks old showed that the DA polyol product was stable over time i.e., it did not undergo a rDA reaction.

### Example 2—Adhesive Polymer Preparation

Various polyurethane polymers were prepared utilising the DA polyol as prepared above, to ascertain its suitability and benefit for use as an adhesive polymer. Table 1, below, provides further details of the reactants used in the Examples which follow.

TABLE 1

| | | Equivalent | NCO | OH value |
|---|---|---|---|---|
| Reactant | Functionality | mass (g/mol) | % | (mgKOH/g) |
| Desmodur VK10L | 2.6 | 135 | 31 | |
| DA polyol | 2 | 443 | — | 127 |
| PC | 2 | 492 | — | 114 |
| PP | 2.2 | 278 | — | 202 |
| SH | 2 | 610 | — | 92 |

For each Example prepared, the isocyanate and polyol* reactants were mixed in 1:1 NCO:OH ratio. The reactants used in in the different Examples are provided below in Table 2. The exact quantities in grams (g) used of each reactant in each Example, can be found in Table 3.

TABLE 2

| Example | | | Ratio of polyols* |
|---|---|---|---|
| Name | Isocyanate | Polyol(s)* | in wt % |
| PU-DA | Desmodur VK10L | DA polyol | — |
| PU-PC | Desmodur VK10L | PC | — |
| PU-PCDA25 | Desmodur VK10L | PC/DA polyol | 75/25 |
| PU-PCDA50 | Desmodur VK10L | PC/DA polyol | 50/50 |
| PU-pp | Desmodur VK10L | PP | — |
| PU-ppDA25 | Desmodur VK10L | PP/DA polyol | 75/25 |
| PU-ppDA50 | Desmodur VK10L | PP/DA polyol | 50/50 |
| PU-SHDA | Desmodur VK10L | SH/DA polyol | 50/50 |

*Here for convenience polyol refers to the DA polyol of Example 1 and the further polyol reactants (PC, PP, SH).

TABLE 3

| | Isocyanate | | DA | | |
|---|---|---|---|---|---|
| | Type | Polyol | polyol (g) | | |
| | Desmodur | Type | (From | Eq. | Eq. |
| Example | VK10L (g) | (g) | Example 1) | NCO | OH |
| PU-DA | 3.68 | 0 | 12.05 | 0.027 | 0.027 |
| | | PC | | | |
| PU-PC | 3.39 | 11.77 | 0 | 0.025 | 0.024 |
| PU-PCDA25 | 3.38 | 9.01 | 2.98 | 0.025 | 0.025 |
| PU-PCDA50 | 3.51 | 6.12 | 6.04 | 0.026 | 0.026 |
| | | PP | | | |
| PU-pp | 4.93 | 10.12 | 0 | 0.037 | 0.036 |
| PU-ppDA25 | 4.69 | 7.83 | 2.74 | 0.035 | 0.034 |
| PU-ppDA50 | 4.35 | 5.38 | 5.51 | 0.032 | 0.032 |
| | | SH | | | |
| PU-SHDA | 3.39 | 7.63 | 5.41 | 0.025 | 0.025 |

The polyurethane polymers as outlined above were prepared by mixing the DA polyol and polyol (where relevant) until a homogenous mixture was obtained. The polyol* was then admixed with the isocyanate to form an adhesive polymer sample.

Curing was carried out at room temperature (RT) under a 15 kg load. It should be noted that the polyurethane polymer based on only PP (PU-PP) as polyol did not cure well, and after a week this sample was still soft at RT. Polymer curing was not a problem for the formulations using PP/DA polyol mixtures.

### Example 3—Adhesive Polymer Testing

All samples containing DA polyol were exposed to a heating profile from 100° C. to 130° C., to ascertain at what temperature the rDA reaction occurred and the polymer sample began to debond. A temperature of 120° C. resulted in the most softening of the polyurethanes containing DA polyol, while the reference (PU-PC) remained solid. As such, it is considered that 120° C. represents the temperature at which the rDA reaction occurs for the DA polyol of Example 1.

### 3a) Lap Shear Test

A lap shear test (method ISO 4587) may be employed to determine the in situ strength of an adhesive polymer sample by placing the adhesive between two substrate plates and applying force to separate the plates—separation occurs once the adhered system has failed; three types of failure can be distinguished, i) cohesive failure (CF), whereby the failure is across the adhesive layer, ii) adhesive failure (AF), whereby the adhesive separates from the substrate surface on at least one side, or iii) substrate failure (SF) where the adhesive is so strong that not the adhesive but the substrate resigns.

An adhesive is considered good when the adhesive strength (AS) is about 3 MPa, and higher values would denote a very good adhesive. When the adhesive strength observed is below 1 MPa the polymer is not a good adhesive. On the other hand, for polymer debonding, a low adhesive strength is favoured, and the aim is an adhesive strength close to zero. As such, for the present invention the aim is to provide an adhesive polymer with a good adhesive strength at room temperature, and as low as possible adhesive strength after thermal treatment (i.e., after the rDA reaction has been initiated).

The adhesive strength after thermal treatment should therefore be at least below 1 MPa and preferably below 0.5 MPa. In use it might be favourable to retain a little amount of strength (0-0.5 MPa) to be able to gradually separate the adhered materials instead of very sudden as could happen for an adhesive strength of zero. Ultimately, before industrial applications, additives could be added to the adhesive to further enhance the properties up to the required levels.

To assess the debonding adhesive strength of the present samples, the lap shear samples were heated at 120° C. for 1 h.

Lap shear testing was carried out with different substrate plates as detailed below:

### Aluminium Substrates

The average adhesive strength for each formulation on aluminium substrates is shown in Table 4, in which adhesive strength (AS) and failure type before and after thermal treatment (to debond the adhesive) as measured by lap shear test of each formulation on aluminium substrates having a single lap joint, with an area of 25×25 mm, and the last column of Table 4 shows the percentage decrease of the adhesive strength.

TABLE 4

| Sample | AS | AS after | Failure | Failure type | Decrease of |
|---|---|---|---|---|---|
| formulation | (MPa) | heating (MPa) | type | after heating | AS (%) |
| PU-PC | 3.0 | 1.6 | AF | CF/AF | 46 |
| PU-PCDA25 | 2.7 | 0.9 | CF | CF | 67 |
| PU-PCDA50 | 5.7 | 0.3 | CF | CF | 95 |
| PU-ppDA25 | 5.6 | 1.8 | AF/CF | CF | 68 |
| PU-ppDA50 | 5.8 | 0.5 | CF | CF | 91 |
| PU-SHDA50 | 5.8 | 0.1 | SF | CF | 98 |

Key: Adhesive strength (AS), cohesive failure (CF), adhesive failure (AF), substrate failure (SF).

The sample containing only DA polyol, PU-DA, became hard and very brittle, resulting in a low adhesive strength of 0.9 MPa; the failure is caused by adhesive fracture (AF).

The sample PU-PC showed an acceptable adhesive strength (3.0 MPa) and adhesive failure. The material was solid but still elastic. After thermal treatment, the adhesive strength is decreased by almost 50%, due to the softening of the material and loss of elasticity upon heating, but it still above 1.0 MPa (i.e. the polymer is still adhesive to a certain extent), as such the adhesive polymer does not have physical properties which facilitate removal and reuse of the adhesive or substrate.

When the ratio between PC- and DA polyol is increased to a 50/50 wt % blend, an increase in the adhesive strength at room temperature is observed. The failure for this formulation is cohesive, which implies that the adhesion of the PU-PC sample is improved by the addition of DA polyol. The combination of the qualities of each polyol, leads to a total adhesive strength of 5.7 MPa. Moreover, the adhesive strength collapses completely after thermal treatment.

For the samples containing PP, this polyol has a functionality of 2.2, which leads to a higher crosslink density than with the PC-polyol which has a functionality of 2. Sample PU-pp, made only with PP and isocyanate has a low adhesive strength, caused by insufficient curing as discussed mentioned above (the sample remained soft after a week).

During the lap shear tests at room temperature both samples PU-ppDA25 and PU-ppDA50 deformation of the aluminium substrates occurred upon failure, the joint-end bent away under the strong shear stress caused by the adhesive. The percentage decrease of the adhesive strength after thermal treatment is comparable to the PU-PCDA formulations. Nevertheless, it is shown that the reversible DA-system is reversible and reproduceable in combination with different polyols.

When combining the DA polyol and the SH-polyol, excellent properties for a reversible adhesive are accomplished, in terms of having an extremely good adhesive strength at room temperature and an adhesive strength close zero upon a thermal treatment.

### Epoxy Glass Substrates

A selection of sample polymers were tested on glass reinforced epoxy substrates (also referred to as epoxy glass substrates) as well to display the potential versatility of the adhesive. These results are shown in Table 5, where adhesive strength and failure type, before and after thermal treatment, as measured by lap shear test of each sample applied between epoxy substrate plates having a single lap joint, with an area of 25×25 mm. The last column of the Table shows the percentage decrease of the tested samples adhesive strength.

TABLE 5

| Sample | AS | AS after | Failure | Failure type | Decrease |
|---|---|---|---|---|---|
| formulation | (MPa) | heating (MPa) | type | after heating | of AS (%) |
| PU-PCDA25 | 2.4 | 0.7 | AF | AF | 73 |
| PU-PCDA50 | 2.8 | 0.0 | AF | AF | 100 |
| PU-ppDA25 | 4.0 | 0.4 | AF | AF/CF | 91 |
| PU-ppDA50 | 5.1 | 0.5 | AF | CF/AF | 91 |

The samples PU-ppDA25 and PU-ppDA50, have good adhesive strengths of respectively 4.0 and 5.1 MPa, and performed slightly better on epoxy substrates than the PC based samples. Upon thermal treatment, the adhesive strengths for both samples decreased by 91%, and provided adhesive strengths well below 1 MPa, allowing debonding of the substrates at low strengths. These samples provide good adhesive polymers which could easily be removed from epoxy substrates to allow for recycling or reuse.

### Recombination of Substrates

The PU-PC and PU-PCDA50 on epoxy substrate samples as tested above, which had been separated after thermal treatment, were subsequently recombined to demonstrate the reusability of the samples. The substrates were placed back on top of each other in the same set-up as during curing and the samples were placed in the oven at 60° C.; the varying parameters, time, load, and days of rest, for different sets can be found in Table 6, below.

TABLE 6

| Sample with | | Duration | | Duration |
|---|---|---|---|---|
| epoxy glass | Temperature | of | Load | of rest |
| substrate | (° C.) | heating (h) | (kg) | (days) |
| PU-PC | 60 | 21 | 10 | 4 |
| PU-PCDA50 | | | | |

The recombined epoxy substrate samples were subjected to lap shear testing as described above. As expected, the PU-PC sample showed no rebonding of the previously debonded epoxy glass substrates, as this sample did not contain any reversible DA/rDA groups. On the other hand, sample PU-PCDA50 showed a restore in adhesive strength to almost 25% of its original strength, which shows that rebonding, and hence reuse, of the PU is possible.

### Example 4—Alternative DA Polyol Preparations

### Example 4a

Alternative DA polyols containing a dimer fatty residue in accordance with the present invention may be prepared utilising a wide range of diols and acids, for example,
a) a dimer acid (Pripol 1006) and 1,6-hexanediol,
b) a dimer acid and mono ethylene glycol,
c) a dimer diol (Pripol 2033) and adipic acid, or
d) a dimer diol and succinic acid.

In these cases, the DA polyol is made by mixing the identified diol and acid in a stepwise fashion at around 220° C. The OH and/or acid value is monitored to follow the completion of the reaction (i.e., an OH value 110 and an acid value <1 mgKOH/g). The reaction mixture is then cooled down to 120° C. Subsequently, the furfuryl alcohol (BP of 171° C.) is added and the mixture is heated back up again to complete the reaction; the furfuryl alcohol end-caps the polyol prepared in the first step. The desired DA polyol can then be made by adding a mono maleimide, for example N-(2-Hydroxyethyl) maleimide (R2), to the polyol and stirring at between 60° C. and 80° C. for between 5 and 8 hours.

### Example 4b

Similar furfuryl alcohol end-capped materials may be prepared by utilising the following:
e) A polyol containing C36 dimer reacted with 6-Maleimidohexanoic acid before end capping with furfuryl alcohol,
f) A C36 diol reacted with 4-(Maleinimido)phenyl isocyanate before end-capping with furfuryl alcohol.

### Example 4c

A further alternative preparation method includes reacting a bismaleimide with furfuryl alcohol at a temperature of between 60° C. and 80° C. for between 5 and 8 hours. The OH terminated adduct may then (optionally) be reacted with a diisocyanate, for example hexamethylene diisocyanate (HDI), at 60° C. for 3 hours before subsequently a C36 dimer diol is added and stirred for 3 hours at 60° C. In this example the dimer part of the DA polyol is introduced as the final process step.

### Example 4d

A further alternative preparation method includes utilisation of an enzyme to allow the preparation of the DA polyol to be achieved at a suitably low temperature, such that the rDA reaction of the DA unit does not occur while the dimer component is being introduced. In this case, the DA unit may be prepared by reacting a bismaleimide (either aliphatic or aromatic) with furfuryl alcohol at between 60° C. and 80° C. for between 5 and 8 hours. Subsequently, the enzyme Candida antarctica lipase-B (CAL-B) (10 wt % of total monomers) and diphenyl ether (200 wt % of total monomers) were added to the OH terminated DA unit and this was reacted with either a C36 diacid or diester (i.e., methyl or ethyl ester of the diacid); this was reacted at 80° C. under nitrogen. After 1 hour, when the reaction mixture was homogeneous, the temperature was slowly increased to 95° C. and this temperature maintained for 3 hours, followed by reducing the pressure to complete the reaction and obtain the final DA polyol. Depending on the molecular weight, the final DA polyol can be dissolved in chloroform, filtered to remove the enzyme and precipitated in cold methanol.

1. A Diels Alder polyol (DA polyol) comprising:
a) a Diels-Alder unit, wherein the Diels-Alder unit is capable of a DA/rDA reaction, and,
b) a dimer fatty residue,
wherein the DA polyol necessarily contains at least two hydroxyl groups and the DA unit is provided by a diene and dienophile which is capable of a DA/rDA reaction.

2. (canceled)

3. (canceled)

4. A DA polyol according to claim 1, wherein the diene is a furan or a furan derivative.

5. A DA polyol according to claim 4, wherein the dienophile is a maleimide or an acrylate.

6. A DA polyol according to claim 1, wherein the dimer fatty residue of the DA polyol is derived from a dimer diacid residue, a dimer diol residue, a dimer diamine residue and/or a dimer diisocyanate residue.

7. (canceled)

8. (canceled)

9. A polymer composition comprising a DA polyol of claim 1.

10. A polymer composition according to claim 9, wherein the polymer composition comprises a polyurethane, polyester, (co-)polyamide, epoxy, polycarbonate, polyacrylate, and combinations or mixed polymers thereof.

11. A polymer composition according to claim 9, wherein the polymer composition comprises the DA polyol and an isocyanate.

12.-16. (canceled)

17. A polymer composition according to claim 9, wherein the polymer composition further comprises at least one polyol.

18. A polymer composition according to claim 9, wherein the polymer composition further comprises at least one dimer-based polyester.

19. (canceled)

20. (canceled)

21. A method of making a polyurethane polymer comprising reacting a DA polyol of claim 1 with an isocyanate to form a polyurethane polymer.

22.-24. (canceled)
